(19) United States
(12) Patent Application Publication
(10) Pub. No.: US 2012/0301583 A1
(43) Pub. Date: Nov. 29, 2012

(54) Oil and Fat Composition for Deep Frying

(75) Inventors: Yuji Nakada, Tokyo (JP); Shoji Matsumoto, Tokyo (JP); Naoko Inaba, Tokyo (JP); Masayoshi Sakaino, Tokyo (JP); Ko Kimura, Tokyo (JP); Hiroshi Shiramasa, Tokyo (JP)

(73) Assignee: J-OIL MILLS, INC., Tokyo (JP)

(21) Appl. No.: 13/576,725

(22) PCT Filed: Mar. 16, 2011
(86) PCT No.: PCT/JP2011/056162

§ 371 Date: Aug. 2, 2012

(30) Foreign Application Priority Data
Mar. 29, 2010 (JP) 2010-074903

(51) Int. Cl. A23D 9/007; A23D 9/04

(52) U.S. Cl. 426/268; 426/545; 426/330.6; 426/417

(57) ABSTRACT

The present invention provides an oil and fat composition that can prevent not only coloring caused by heating and cooked odor during heat cooking, but also increase in acid value, as well as that can endure long-term use. The oil and fat composition, which can prevent coloring caused by heating, cooked odor, and increase in acid value, can be obtained by incorporating 0.1 ppm or more and 10 ppm or less of a phosphorus component, and ascorbic acid and/or an ascorbic acid derivative in an ascorbic acid equivalent of 2 ppm or more and 130 ppm or less into an edible oil and fat.

### TECHNICAL FIELD

The present invention relates to an oil and fat composition for deep frying that has excellent heat resistance during heat cooking, and that particularly prevents coloring caused by heating, increase in acid value, and cooked odor.

### BACKGROUND

As oils for cooking deep-fried foods such as fried food and tempura, soybean oil, rapeseed oil, palm oil, and other edible oils and fats are used singly or in combination of two or more. In heat cooking performed by putting foods in highly-heated cooking oil, i.e., deep-fry cooking, the influence of oxygen, heat, water, components eluted from food stuff, etc., leads to various degradation reactions. Upon heating, oils and fats undergo thermal oxidation, thermal decomposition, thermal polymerization, hydrolysis, and other reactions, resulting in coloring, increased acid value, increased viscosity, generation of cooked odor, etc. Consequently, the cooking environment is worsened, and the quality of deep-fried foods is deteriorated. For this reason, oils and fats cannot be used for a long time.

In the prior art for preventing thermal degradation during deep-fry cooking, oils and fats are refined under more stringent conditions to remove, as much as possible, phospholipids, trace metals, and like substances that are known to promote degradation.

In contrast, Patent Document 1 discloses a method for preventing thermal degradation by incorporating a small amount of phosphorus component into oils and fats. Further, Patent Document 2 discloses a method for preventing odor caused by thermal degradation by incorporating ascorbic acid into oils and fats.

However, the method of Patent Document 1 was not necessarily effective to prevent increase in acid value, as shown in Comparative Examples described later.

Moreover, the method of Patent Document 2 failed to sufficiently prevent coloring caused by heating and increase in acid value, as shown in Comparative Examples described later.

### SUMMARY OF INVENTION

The present invention provides an oil and fat composition that prevents not only coloring caused by heating and cooked odor during heat cooking, but also increases in acid value, as well as that endures long-term use.

In accordance with present invention embodiments, an edible oil and fat can be prevented from coloring caused by heating, increasing in acid value, and generating cooked odor, by incorporating predetermined amounts of a phosphorus component, ascorbic acid and/or an ascorbic acid derivative into the oil and fat. More specifically, the present inventors found that when 0.1 ppm or more and 10 ppm or less of a phosphorus component, and ascorbic acid and/or an ascorbic acid derivative in an ascorbic acid equivalent of 2 ppm or more and 130 ppm or less were incorporated into an edible oil and fat, the effect of preventing coloring and cooked odor of the edible oil and fat caused by heating was markedly improved, while the effect of preventing increase in acid value, which could not have been improved by single use of each component, was achieved. The present invention has thus been accomplished.

### DETAILED DESCRIPTION

In accordance with embodiments of the present invention, an oil and fat composition prevents not only coloring caused by heating and cooked odor during heat cooking, but also increases in acid value, as well as endures long-term use. The oil and fat composition, which can prevent coloring caused by heating, cooked odor, and increase in acid value, can be obtained by incorporating 0.1 ppm or more and 10 ppm or less of a phosphorus component, and ascorbic acid and/or an ascorbic acid derivative in an ascorbic acid equivalent of 2 ppm or more and 130 ppm or less into an edible oil and fat.

Examples of the phosphorus-derived component contained in the oil and fat composition of the present invention include, as described later, crude oil, degummed oil, and other oils and fats containing large amounts of various phosphorus components; lecithin, phosphoric acid, phosphate, etc. There is no limitation on the type of crude oil and degummed oil, and any oils and fats can be used.

Usable examples of the lecithin include vegetable lecithin, such as soybean lecithin, rapeseed lecithin, corn lecithin, and safflower lecithin; and animal lecithin, such as egg yolk lecithin. The lecithin may be either naturally-occurring, unrefined lecithin (crude lecithin) or highly-refined lecithin (refined lecithin) obtained by removing impurities, such as neutral lipids, fatty acids, carbohydrates, proteins, mineral salts, sterols, and pigments, from crude lecithin by a general method. In addition, the lecithin may be fractionated lecithin obtained by fractionation of phosphatidylcholine in lecithin; lysolecithin obtained by lyso treatment; or modified lecithin, such as enzymatic lecithin obtained by enzymolysis.

Examples of the phosphate include tripotassium phosphate, tricalcium phosphate, trimagnesium phosphate, diammonium hydrogen phosphate, ammonium dihydrogen phosphate, dipotassium hydrogen phosphate, potassium dihydrogen phosphate, calcium monohydrogen phosphate, calcium dihydrogen phosphate, disodium hydrogen phosphate, sodium dihydrogen phosphate, trisodium phosphate, tetrapotassium pyrophosphate, calcium dihydrogen pyrophosphate, disodium dihydrogen pyrophosphate, tetrasodium pyrophosphate, potassium polyphosphate, sodium polyphosphate, potassium metaphosphate, sodium metaphosphate, hydrates thereof, and the like.

Although the oil and fat composition of the present invention essentially comprises a predetermined amount of phosphorus component, the method of adding the phosphorus component to the composition is not particularly limited. The oil and fat composition of the present invention can be obtained industrially, for example, by moderating the conventional degree of refining of edible oils and fats so that a predetermined amount of phosphorus component is remained, or by adding a phosphorus-derived component to refined edible oils and fats (i.e., those that have been subjected to deodorization and are free of phosphorus components) to adjust the phosphorus content. The method of adding a phosphorus-derived component to refined edible oils and fats is preferable because a small amount of phosphorus component can be easily adjusted.

The phosphorus-derived component is at least one member selected from the group consisting of crude oil obtained by expression, extraction, press expression, or the like; intermediate oil products, such as degummed oil and roughly refined oil; and phosphorus compounds, such as lecithin, phosphoric acid, and phosphate. The phosphorus-derived component is preferably expressed oil and/or extracted oil, degummed oil, lecithin, or phosphoric acid and/or phosphate.

In the present invention, the crude oil refers to an oil and fat obtained from oilseed raw materials by expression, extraction, press expression, or the like. The degummed oil refers to an oil and fat obtained by removing gummy matter from crude oil in the degumming process. The intermediate oil products refer to oils and fats, etc., obtained without performing part of the refining process of oils and fats, such as degumming and deoxidation.

In the present invention, the term “phosphorus-derived component” is used in the sense of a component that contains phosphorus and can be used as a starting material of the oil and fat composition.

In the present invention, examples of the ascorbic acid and ascorbic acid derivative include ascorbic acid, ascorbate, sodium ascorbyl phosphate, magnesium ascorbyl phosphate, ascorbyl tetraisopalmitate, ascorbic acid esters, etc. Preferable are ascorbic acid and/or ascorbic acid esters, more preferable are ascorbic acid esters, and most preferable is ascorbyl palmitate. Ascorbic acid is not satisfactory in terms of reproducibility because of its low solubility in oils and fats, while ascorbic acid esters are easy to handle because of their excellent solubility in oils and fats.

The ascorbic acid esters are obtained by ester bonding of fatty acid and ascorbic acid, and improve the oil solubility of the ascorbic acid.

In the present invention, the ascorbic acid equivalent is a value obtained by converting the amount of ascorbic acid derivative to the amount of ascorbic acid. More specifically, assuming that the content (ppm) of ascorbic acid derivative is A, the number of ascorbic acid molecules per molecule of the ascorbic acid derivative is B, the molecular weight of the ascorbic acid is C, and the molecular weight of the ascorbic acid derivative is D, the ascorbic acid equivalent (ppm) is calculated by the formula: A×B×C/D.

The oil and fat composition obtained by the present invention characteristically comprises 0.1 ppm or more and 10 ppm or less of a phosphorus component, and ascorbic acid and/or an ascorbic acid derivative in an ascorbic acid equivalent of 2 ppm or more and 130 ppm or less. Different from conventional oil and fat compositions, the oil and fat composition obtained by the present invention can sufficiently prevent coloring caused by heating, increase in acid value, and cooked odor, and this composition is perfectly suitable as an oil and fat composition for deep frying, for which long-term heat resistance is required.

The type of edible oil and fat used in the present invention is not particularly limited, and any edible oils and fats can be used. Specific examples thereof include vegetable oils and fats, such as soybean oil, rapeseed oil, palm oil, corn oil, olive oil, sesame oil, safflower oil, sunflower oil, cotton oil, rice bran oil, peanut oil, palm kernel oil, and coconut oil; animal fats, such as beef tallow and lard; and processed fats obtained by subjecting the above oils and fats to fractionation, hydrogenation, transesterification, etc. These can be used singly or in combination of two or more. In particular, remarkable effects are obtained by using oils and fats containing soybean oil.

Additionally, oils and fats containing other antioxidants, emulsifiers, and flavoring agents can also be used, as long as the effects of the present invention are not impaired.

The above edible oils can be produced by subjecting their oilseed raw materials to press extraction and/or solvent extraction to thereby obtain crude oil, and further subjecting the crude oil to extraction and refining.

Press extraction is performed by applying high pressure to raw materials, and squeezing oil from the cells. Press extraction is suitable for oilseed raw materials with a relatively high oil content, such as sesame.

Solvent extraction is performed in such a manner that oil seed raw materials are subjected to pressing or press extraction, the resulting residue is brought into contact with a solvent to extract oil as a solvent solution, and the solvent is removed from the resulting solution to obtain the oil. Solvent extraction is suitable for raw materials with a low oil content, such as soybeans. Usable solvents are hexane etc.

As the refining means, a general refining process of vegetable oils can be used. More specifically, impurities are generally removed in the following order: (extracted oil) crude oil→degummed oil→alkali refined oil→bleached oil→deodorized oil (refined oil). As the operations “degumming”, “deoxidation”, “decoloring”, and “deodorization” conducted between each of the above steps, general degumming, deoxidation, decoloring, deodorization, etc., can be employed.

Degumming is a process of removing gummy matter comprising a phospholipid as a main component from oil by hydration. Deoxidation is a process of removing free fatty acids from oil as soap components by treatment with alkaline water.

Decoloring is a process of removing pigments from oil by adsorption into activated white clay.

Deodorization is a process of removing odor components from oil by steam distillation under reduced pressure. As for olive, sesame, safflower, and sunflower, their crude oils obtained by press extraction and/or solvent extraction may be used for edible purposes as they are or after being subjected to simple water washing.

The phosphorus-derived component contained in the oil and fat composition of the present invention is at least one member selected from crude oils obtained by expression, extraction, press extraction, or the like, and intermediate oil products obtained without performing part of the process, such as degumming and deoxidation. The oilseed raw material is not particularly limited.

The amount of the phosphorus component of the oil and fat composition of the present invention is 0.1 ppm or more and 10 ppm or less, preferably 0.8 ppm or more and 10 ppm or less, more preferably 0.8 ppm or more and 8.0 ppm or less, and most preferably 1.0 ppm or more and 5.0 ppm or less. When the amount of phosphorus component is low, the effect of preventing coloring caused by heating is insufficient; conversely, when the amount is high, coloring caused by heating may be promoted.

The oil and fat composition of the present invention essentially comprises at least one of ascorbic acid and an ascorbic acid derivative.

The amount of ascorbic acid and/or ascorbic acid derivative added in the present invention is 2 ppm or more and 130 ppm or less as an ascorbic acid equivalent. When the ascorbic acid equivalent is too low or too high, sufficient heat resistance may not be obtained.

When ascorbic acid is added in the present invention, the equivalent of the remaining ascorbic acid is preferably 2 ppm or more and 28 ppm or less, more preferably 2 ppm or more and 9 ppm or less, and most preferably 4 ppm or more and 9 ppm or less. When the amount of ascorbic acid is too high, the ascorbic acid may be difficult to sufficiently dissolve in the oil and fat.

When the ascorbic acid is added to the oil and fat, a 0.2% to 1% aqueous solution thereof is prepared, and a predetermined amount of the solution is added to the oil and fat. While stirring at a reduced pressure of 1 to 50 Torr, the mixture is heated to 50 to 100° C. Water is sufficiently removed, and filtration is performed. Thus, the ascorbic acid can be added to the oil and fat.

When an ascorbic acid ester is added in the present invention, the amount of ascorbic acid ester is preferably 10 ppm or more and 130 ppm or less, more preferably 10 ppm or more and 50 ppm or less, as an ascorbic acid equivalent. When the amount of ascorbic acid ester is too low or too high, heat resistance is insufficient.

The fatty acid bonded to the ascorbic acid ester is not particularly specified; however, ascorbic acid stearate and ascorbic acid palmitate are preferable. Ascorbic acid palmitate is more preferable. The ascorbic acid ester can be added to the oil and fat in such a manner that a predetermined amount of ascorbic acid ester is added to the oil and fat, and the mixture is heated to 50 to 130° C. and stirred.

Moreover, the present invention provides a food deep-fried in an oil and fat composition comprising 0.1 ppm or more and 10 ppm or less of a phosphorus component, and ascorbic acid and/or an ascorbic acid derivative in an ascorbic acid equivalent of 2 ppm or more and 130 ppm or less.

Examples of the food include tempura, croquettes, fried pork cutlets, fried chicken, fried fish, fried potato, fried tofu, fried rice snack, snack foods, doughnuts, instant noodles, and the like.

Furthermore, the present invention provides a method for preventing increase in the acid value of an oil and fat composition for deep frying, the method comprising incorporating 0.1 ppm or more and 10 ppm or less of a phosphorus component, and ascorbic acid and/or an ascorbic acid derivative in an ascorbic acid equivalent of 2 ppm or more and 130 ppm or less into an edible oil and fat.

The estimated usable period of edibles oils and fats can be extended by performing the above method of the present invention.

### EXAMPLES

The present invention is described in more detail below with reference to Examples and Comparative Examples. However, the following Examples do not limit the present invention. The term “parts” means parts by weight.

The oils and fats, ascorbic acid, etc., used in the following are as follows.

### (Oil and Fat)

Refined soybean oil (produced by J-Oil Mills, Inc.; soybean refined oil, no phosphorus component was detected)

Refined rapeseed oil (produced by J-Oil Mills, Inc.; rapeseed refined oil, no phosphorus component was detected)

Refined palm oil (produced by J-Oil Mills, Inc.; refined palm olein, no phosphorus component was detected)

### (Phosphorus-Derived Component)

Phosphoric acid (produced by Wako Pure Chemical Industries, Ltd.)

Soybean-derived degummed oil (produced by J-Oil Mills, Inc.; phosphorus component: 70 or 200 ppm)

Rapeseed-derived degummed oil (produced by J-Oil Mills, Inc.; phosphorus component: 80 ppm)

### (Ascorbic Acid and Ascorbic Acid Derivative)

Ascorbic acid (L-ascorbic acid, produced by DSM Nutrition Japan K.K.); molecular weight: 176.12

Ascorbyl palmitate (L-ascorbyl palmitate, produced by Mitsubishi-Kagaku Foods Corporation); molecular weight: 414.54

Moreover, in the following, the evaluation of a fry test, etc., was performed as follows.

### (Fry Test)

A 3-L fryer (Mach Fryer F-3H, produced by Mach Kiki Co., Ltd.) was filled with 3.4 kg of oil and fat, and heated to 180° C. Frozen chicken for frying (400 g; broiler chicken for frying, produced by Ajinomoto Frozen Food Co., Inc.) was fried therein for 5 minutes. The same operation was repeated 5 times every 2 hours. Thus, the test was performed for 10 hours. The same procedure was repeated for 6 days. The color tone and acid value of samples after 60 hours from the start of frying were measured.

### (Simple Heat Test)

A stainless steel container (5 cm in diameter) was filled with 10 g of oil and fat, and heated at 180° C. for 6 hours. The acid value and color tone of the obtained oil and fat compositions were measured.

### (Analysis of Phosphorus Component)

Using an ICP emission spectrophotometer (iCAP6000, produced by Thermo Fisher Scientific K.K.), the analysis was performed by high-frequency plasma emission spectrometry.

### (Amount of Remaining Ascorbic Acid)

An oil and fat was placed in a sealable container. A 5% aqueous metaphosphoric acid solution in an amount equivalent to the amount of the oil and fat, and hexane in an amount twice the amount of the oil and fat were added, and the mixture was stirred by shaking. After still standing, the absorbance of the aqueous layer at 246 nm was measured. Separately, a calibration curve was prepared with a known amount of an aqueous ascorbic acid solution, and quantitative determination was carried out.

### (Color Tone)

The color tone was measured with a Lovibond tintometer (PFX990, produced by The Tintometer Ltd.) using a 1-inch cell to calculate the 10R+Y value.

### (Acid Value)

The amount of potassium hydroxide (mg) required for neutralizing free fatty acids contained in 1 g of sample was measured according to the Standard Method for the Analysis of Fats, Oils and Related Materials 2.3.1-1996.

### (Analysis of Volatile Component)

A magnetic plate was filed with 600 g of oil and fat, and heated at 180° C. for 80 hours. The oil and fat heated for 80 hours was analyzed by GC-MS (6890N/5975BinertXL, produced by Agilent Technologies, Inc). The analysis conditions are shown below. The oil and fat (50 mg) was placed in an analyzing cup and heated to 180° C. Helium gas was passed through a headspace portion, and volatilized components were collected for 10 minutes. The column used was ZB-WAXplus (produced by Phenomenex; 60 m×0.25 mmi.d , film thickness: 0.25 μm). The temperature conditions were as follows: 40° C. (10 minutes)→temperature increase at 2° C./min→100° C.→temperature increase at 5° C./min→210° C. (10 minutes). Helium was used as the carrier gas. Among the volatile components, the total peak area of 23 components (butanal, hexanal, pentanal, nonanal, heptanal, 2-pentenal, 2-butenal, 2-propenal, 2-hexenal, 2-heptenal, 2-octenal, 2-decenal, 2-nonenal, 2-undecenal, 2,4-heptadienal, 2,4-nonadienal, 2,4-decadienal, 2-pentene- 1 -ol, 1-octen-3-ol, 1-pentanol, 1-heptanol, octane, and 2-pentylfuran) known as degradation products of fatty acids, which were the main components of the oil and fat, was calculated.

### (Evaluation of Cooked Odor)

A magnetic plate was filled with 600 g of oil and fat, and heated at 180° C. for 80 hours. Regarding the odor at a height of 15 cm from the oil surface of the oil and fat, the intensity of the entire odor and the intensity of deterioration odor were sensuously evaluated by 20 professional panelists. The scales were as follows: 5: very strong, 4: strong, 3: normal, 2: weak, 1: very weak, and 0: no odor. The evaluation results were expressed as the average values of the panelists, and significance tests were carried out.

### Example 1

Refined soybean oil was heated to 70° C., and 1 part by weight of a 0.5% aqueous ascorbic acid solution was added and mixed with 100 parts by weight of the refined soybean oil. While stirring at 70° C. at a reduced pressure of 40 Torr or less, dehydrating treatment was carried out for 20 minutes. After filtration, 2 parts by weight of degummed soybean oil (oil obtained by adding water to extracted oil to hydrate gummy matter comprising a phospholipid as a main component) was added, thereby preparing an oil and fat composition. When the amount of the remaining ascorbic acid was determined, it was 8.6 ppm as an ascorbic acid equivalent.

### Example 2

Refined soybean oil was heated to 100° C., and 0.01 parts by weight of ascorbyl palmitate was added and mixed with 100 parts by weight of the refined soybean oil. The mixture was mixed at 100° C. for 10 minutes, thereby preparing an ascorbyl palmitate-added oil and fat. The obtained ascorbyl palmitate-added oil and fat (30 parts by weight) was added to 70 parts by weight of the refined soybean oil. Further, 2 parts by weight of degummed soybean oil was added, thereby preparing an oil and fat composition.

### Example 3

Refined soybean oil was heated to 70° C., and 1 part by weight of a 0.5% aqueous ascorbic acid solution was added and mixed with 100 parts by weight of the refined soybean oil. While stirring at 70° C. at a reduced pressure of 40 Torr or less, dehydration treatment was carried out for 20 minutes. After filtration, 2 parts by weight of degummed soybean oil was added, thereby preparing an oil and fat composition. When the amount of the remaining ascorbic acid was determined, it was 5.0 ppm as an ascorbic acid equivalent.

### Examples 4 and 5

Refined soybean oil was heated to 100° C., and 0.03 parts by weight of ascorbyl palmitate was added and mixed with 100 parts by weight of the refined soybean oil. The mixture was mixed at 100° C. for 10 minutes, thereby obtaining an ascorbyl palmitate-containing oil and fat composition. The ascorbyl palmitate-containing oil and fat composition was added to the refined soybean oil according to the formulations shown in Table 1. Further, 2 parts by weight of degummed soybean oil was added, thereby preparing oil and fat compositions.

### Example 6

Refined soybean oil was heated to 100° C., and 0.003 parts by weight of ascorbyl palmitate was added and mixed with 100 parts by weight of the refined soybean oil. To an oil and fat composition obtained by mixing the mixture at 100° C. for 10 minutes, 2 parts by weight of degummed rapeseed oil was added, thereby preparing an oil and fat composition.

### Example 7

Refined soybean oil was heated to 100° C., and 0.003 parts by weight of ascorbyl palmitate was added and mixed with 100 parts by weight of the refined soybean oil. To an oil and fat composition obtained by mixing the mixture at 100° C. for 10 minutes, 0.0005 parts by weight of phosphoric acid was added, thereby preparing an oil and fat composition.

### Examples 8 to 10

Refined rapeseed oil, refined palm olein, and blended oil of refined soybean oil and refined rapeseed oil (1:1) were separately heated to 100° C., and 0.003 parts by weight of ascorbyl palmitate was added to 100 parts by weight of each of the above edible oils. Further, 2 parts by weight of degummed soybean oil was added, thereby preparing oil and fat compositions.

### Examples 11 to 16

Refined soybean oil was heated to 100° C., and ascorbyl palmitate was added to 100 parts by weight of the refined soybean oil so that the ascorbic acid equivalent was finally 0.0012 parts by weight. After mixing at 100° C. for 10 minutes, degummed soybean oil was further added according to the formulations shown in Tables 2 and 3, thereby preparing oil and fat compositions.

### Comparative Example 1

Refined soybean oil produced through a general refining process was used.

### Comparative Example 2

Degummed soybean oil (2 parts by weight) was added to 100 parts by weight of refined soybean oil, thereby preparing an oil and fat composition.

### Comparative Example 3

Refined soybean oil was heated to 70° C., and 1 part by weight of a 0.5% aqueous ascorbic acid solution was added and mixed with 100 parts by weight of the refined soybean oil. While stirring at 70° C. at a reduced pressure of 40 Torr or less, dehydration treatment was carried out for 20 minutes, followed by filtration, thereby preparing an oil and fat composition. When the amount of the remaining ascorbic acid was determined, it was 5.2 ppm as an ascorbic acid equivalent.

### Comparative Example 4

The ascorbyl palmitate-added oil and fat (30 parts by weight) obtained in Example 2 was added to 70 parts by weight of refined soybean oil, thereby preparing an oil and fat composition.

### Comparative Example 5

Refined soybean oil was heated to 100° C., and 0.011 parts by weight of ascorbyl palmitate was added and mixed with 100 parts by weight of the refined soybean oil. The mixture was mixed at 100° C. for 10 minutes, thereby preparing an oil and fat composition.

### Comparative Example 6

Refined rapeseed oil produced through a general refining process was used.

### Comparative Example 7

Refined palm olein produced through a general refining process was used.

### Comparative Example 8

Blended oil of refined soybean oil and refined rapeseed oil at 1:1 produced through a general refining process was used.

Tables 1 to 5 show the formulations of the oils and fats of Examples 1 to 16 and Comparative Examples 1 to 8.

TABLE 1

| | Exam- | Exam- | Exam- | Exam- | Exam- | |
|---|---|---|---|---|---|---|
| | ple 1 | ple 2 | ple 3 | ple 4 | ple 5 | Example 6 |
| Edible oil | Soy- | Soy- | Soy- | Soy- | Soy- | Soybean |
| seed | bean | bean | bean | bean | bean | oil |
| | oil | oil | oil | oil | oil | |
| Ascorbic | + | − | + | − | − | − |
| acid | | | | | | |
| Ascorbyl | − | + | − | + | + | + |
| palmitate | | | | | | |
| Degummed | + | + | + | + | + | − |
| soybean oil | | | | | | |
| Degummed | − | − | − | − | − | + |
| rapeseed oil | | | | | | |
| Phosphoric | − | − | − | − | − | − |
| acid | | | | | | |
| Ascorbic | 8.6 | 12 | 5.0 | 42 | 125 | 12 |
| acid | | | | | | |
| equivalent | | | | | | |
| (ppm) | | | | | | |
| Phosphorus | 1.4 | 4.0 | 1.4 | 1.4 | 1.4 | 1.6 |
| component | | | | | | |
| (ppm) | | | | | | |

TABLE 2

| | Ex- | | | | | |
|---|---|---|---|---|---|---|
| | am- | Exam- | | Example | Exam- | Exam- |
| | ple 7 | ple 8 | Example 9 | 10 | ple 11 | ple 12 |
| Edible oil | Soy- | Rape- | Palmolein | Soybean | Soy- | Soy- |
| seed | bean | seed | | oil + | bean | bean |
| | oil | oil | | rapeseed | oil | oil |
| | | | | oil (1:1) | | |
| Ascorbic | − | − | − | − | − | − |
| acid | | | | | | |
| Ascorbyl | + | + | + | + | + | + |
| palmitate | | | | | | |
| Degummed | − | + | + | + | + | + |
| soybean oil | | | | | | |
| Degummed | − | − | − | − | − | − |
| rapeseed oil | | | | | | |
| Phosphoric | + | − | − | − | − | − |
| acid | | | | | | |
| Ascorbic | 12 | 12 | 12 | 12 | 12 | 12 |
| acid | | | | | | |
| equivalent | | | | | | |
| (ppm) | | | | | | |
| Phosphorus | 5.0 | 1.4 | 1.4 | 1.4 | 0.1 | 0.8 |
| component | | | | | | |
| (ppm) | | | | | | |

TABLE 3

| | Example 13 | Example 14 | Example 15 | Example 16 |
|---|---|---|---|---|
| Edible oil | Soybean | Soybean | Soybean | Soybean |
| seed | oil | oil | oil | oil |
| Ascorbic | − | − | − | − |
| acid | | | | |
| Ascorbyl | + | + | + | + |
| palmitate | | | | |
| Degummed | + | + | + | + |
| soybean oil | | | | |
| Degummed | − | − | − | − |
| rapeseed oil | | | | |
| Phosphoric | − | − | − | − |
| acid | | | | |
| Ascorbic | 12 | 12 | 12 | 12 |
| acid | | | | |
| equivalent | | | | |
| (ppm) | | | | |
| Phosphorus | 2.7 | 5.0 | 7.5 | 10 |
| component | | | | |
| (ppm) | | | | |

TABLE 4

| | Compar- | Compar- | Compar- | Compar- | Compar- |
|---|---|---|---|---|---|
| | ative | ative | ative | ative | ative |
| | Example 1 | Example 2 | Example 3 | Example 4 | Example 5 |
| Edible oil | Soybean | Soybean | Soybean | Soybean | Soybean |
| seed | oil | oil | oil | oil | oil |
| Ascorbic | − | − | + | − | − |
| acid | | | | | |
| Ascorbyl | − | − | − | + | + |
| palmitate | | | | | |
| Degummed | − | + | − | − | − |
| soybean oil | | | | | |
| Degummed | − | − | − | − | − |
| rapeseed oil | | | | | |
| Phosphoric | − | − | − | − | − |
| acid | | | | | |
| Ascorbic | 0 | 0 | 5.2 | 13 | 47 |
| acid | | | | | |
| equivalent | | | | | |
| (ppm) | | | | | |
| Phosphorus | 0 | 1.4 | 0 | 0 | 0 |
| component | | | | | |
| (ppm) | | | | | |

TABLE 5

| | Comparative | Comparative | Comparative |
|---|---|---|---|
| | Example 6 | Example 7 | Example 8 |
| Edible oil | Rapeseed oil | Palm olein | Soybean oil + |
| seed | | | Rapeseed oil |
| | | | (1:1) |
| Ascorbic | − | − | − |
| acid | | | |
| Ascorbyl | − | − | − |
| palmitate | | | |
| Degummed | − | − | − |
| soybean oil | | | |
| Degummed | − | − | − |
| rapeseed oil | | | |
| Phosphoric | − | − | − |
| acid | | | |
| Ascorbic | 0 | 0 | 0 |
| acid | | | |
| equivalent | | | |
| (ppm) | | | |
| Phosphorus | 0 | 0 | 0 |
| component | | | |
| (ppm) | | | |

### Test Example 1

Using the oil and fat compositions of Examples 1 and 2, and Comparative Examples 1 to 4, the fry test was performed. Table 6 shows the results. The color tone and acid value were expressed as relative values with respect to the results of Comparative Example 1, which were assumed as 100.

TABLE 6

| | | | Com- | Com- | Com- | |
|---|---|---|---|---|---|---|
| | | | parative | parative | parative | |
| | | | Exam- | Exam- | Exam- | Comparative |
| | Example 1 | Example 2 | ple 1 | ple 2 | ple 3 | Example 4 |
| Color | 83 | 80 | 100 | 92 | 100 | 90 |
| tone | | | | | | |
| Acid | 88 | 85 | 100 | 109 | 108 | 95 |
| value | | | | | | |

In Examples 1 and 2 of the present invention, which used ascorbic acid or ascorbyl palmitate, and a phosphorus component, the color tone and acid value were both significantly lower than those of Comparative Example 1, which did not use these components.

Comparatively, in Comparative Example 2, which added only a phosphorus component, the color tone was lower, while the acid value was higher than that of Comparative Example 1. In Comparative Example 3, which added ascorbic acid, the color tone showed no difference from that of Comparative Example 1, while the acid value was higher than that of Comparative Example 1. Accordingly, it was found that in terms of acid value, the oils and fats of Comparative Examples 2 and 3 had inferior heat resistance. Moreover, in Comparative Example 4, which added ascorbyl palmitate, the color tone and acid value were slightly lower, but not sufficient.

Thus, the combination of a phosphorus component (Comparative Example 2) and ascorbic acid (Comparative Example 3) had an unexpected effect of significantly reducing both the color tone and the acid value, as shown in Example 1. Furthermore, the coexistence of a phosphorus component (Comparative Example 2) and ascorbyl palmitate (Comparative Example 4) resulted in an effect of significantly reducing both the color tone and the acid value, as shown in Example 2.

### Test Example 2

Using the oil and fat compositions of Examples 1 and 2, and Comparative Examples 1 to 3 and 5, volatile components were measured during heating. Relative values with respect to the total peak area of the volatile components of Comparative Example 1, which were assumed as 100, were calculated. Table 7 shows the results.

TABLE 7

| | | | Com- | Com- | Com- | |
|---|---|---|---|---|---|---|
| | | | parative | parative | parative | Compar- |
| | Exam- | Exam- | Exam- | Exam- | Exam- | ative |
| | ple 1 | ple 2 | ple 1 | ple 2 | ple 3 | Example 5 |
| Volatile | 37 | 51 | 100 | 79 | 82 | 81 |
| component | | | | | | |
| amount | | | | | | |

In Examples 1 and 2 of the present invention, which used ascorbic acid or ascorbyl palmitate, and a phosphorus component, the reduction of volatile components, which caused cooked odor, was about 50 to 60%, compared to Comparative Example 1, which did not add these components.

Comparatively, in Comparative Example 2, which added only a phosphorus component, Comparative Example 3, which added only ascorbic acid, and Comparative Example 5, which added only ascorbyl palmitate, the reduction of volatile components, which caused cooked odor, was only about 20%, compared to Comparative Example 1, which did not add these components.

Thus, Examples 1 and 2 of the present invention, which used ascorbic acid or ascorbyl palmitate, and a phosphorus component, showed more significant reduction (about 50 to 60%) than the total reduction of single use of each component (about 40%).

### Test Example 3

Each pair of Example 1 and Comparative Example 1, and Example 2 and Comparative Example 1 was subjected to sensory evaluation of cooked odor. Table 8 shows the results.

TABLE 8

| | | | Comparative |
|---|---|---|---|
| | Example 1 | Significance test | Example 1 |
| Intensity of entire odor | 2.9 | * | 3.3 |
| Intensity of degradation | 1.9 | * | 2.3 |
| odor | | | |
| | | | Comparative |
| | Example 2 | Significance test | Example 1 |
| Intensity of entire odor | 2.4 | ** | 2.9 |
| Intensity of degradation | 1.1 | ** | 1.6 |
| odor | | | |

* p < 0.05
** p < 0.01

As with the results of the above measurement of volatile components during heating, it was confirmed that the intensity of the entire odor and the intensity of degradation odor of the oil and fat compositions of Examples 1 and 2 with less volatile components were significantly suppressed.

### Test Example 4

Using the oil and fat compositions of Examples 1 and 3, and Comparative Example 1, the fry test was performed. Relative values with respect to the results of Comparative Example 1, which were assumed as 100, were calculated. Table 9 shows the results.

TABLE 9

| | | | Comparative |
|---|---|---|---|
| | Example 1 | Example 3 | Example 1 |
| Color tone | 83 | 69 | 100 |
| Acid value | 88 | 51 | 100 |

Compared to Comparative Example 1, the color tone and acid value of Examples 1 and 3, which added degummed soybean oil and ascorbic acid in combination, were significantly lower. It was found that remaining ascorbic acid at least in an ascorbic acid equivalent of 5 ppm led to excellent heat resistance.

### Test Example 5

Using the oil and fat compositions of Examples 2, 4, and 5, and Comparative Examples 1 and 2, the fry test was performed. Relative values with respect to the results of Comparative Example 1, which were assumed as 100, were calculated. Table 10 shows the results.

TABLE 10

| | Exam- | Exam- | Exam- | Comparative | Comparative |
|---|---|---|---|---|---|
| | ple 2 | ple 4 | ple 5 | Example 1 | Example 2 |
| Color tone | 80 | 84 | 85 | 100 | 92 |
| Acid value | 85 | 83 | 84 | 100 | 109 |

Compared to Comparative Example 1, or Comparative Example 2, which added only degummed soybean oil, the color tone and acid value of Examples 2, 4, and 5, which added degummed soybean oil and ascorbyl palmitate in combination, were significantly lower. Thus, it was found that the addition of ascorbyl palmitate in an ascorbic acid equivalent of 10 ppm to 130 ppm led to excellent heat resistance.

### Test Example 6

Using the oil and fat compositions of Examples 2 and 6, and Comparative Example 1, the fry test was performed. Relative values with respect to the results of Comparative Example 1, which were assumed as 100, were calculated. Table 11 shows the results.

TABLE 11

| | | | Comparative |
|---|---|---|---|
| | Example 2 | Example 6 | Example 1 |
| Color tone | 80 | 81 | 100 |
| Acid value | 85 | 86 | 100 |

In both cases of using degummed soybean oil and degummed rapeseed oil as a phosphorus component, the color tone and acid value were significantly lower than those of Comparative Example 1. Thus, it was found that the addition of either of degummed soybean oil and degummed rapeseed oil as a phosphorus component led to excellent heat resistance.

### Test Example 7

Using the oil and fat compositions of Examples 14 and 7, and Comparative Example 1, the simple heat test was performed. Relative values with respect to the results of Comparative Example 1, which were assumed as 100, were calculated. Table 12 shows the results.

TABLE 12

| | | | Comparative |
|---|---|---|---|
| | Example 14 | Example 7 | Example 1 |
| Color tone | 65 | 76 | 100 |
| Acid value | 65 | 89 | 100 |

In both cases of using degummed soybean oil and phosphoric acid as a phosphorus component, the color tone and acid value were significantly lower than those of Comparative Example 1. Thus, it was found that the addition of either of degummed soybean oil and phosphoric acid as a phosphorus component led to excellent heat resistance.

### Test Example 8

Using the oil and fat compositions of Examples 8, 9, 10, and 13, and Comparative Examples 1, 6, 7, and 8, the simple heat test was performed. Relative values with respect to the results of Comparative Examples using the same base edible oil seeds, which were assumed as 100, were calculated. Table 13 shows the results.

TABLE 13

| | Example | Comparative | | Comparative | | Comparative | Example | Comparative |
|---|---|---|---|---|---|---|---|---|
| | 13 | Example 1 | Example 8 | Example 6 | Example 9 | Example 7 | 10 | Example 8 |
| Edible | Soybean | Soybean | Rapeseed | Rapeseed | Palmolein | Palmolein | Soybean | Soybean |
| oil seed | oil | oil | oil | oil | | | oil + | oil + |
| | | | | | | | rapeseed | rapeseed |
| | | | | | | | oil (1:1) | oil (1:1) |
| Color | 36 | 100 | 79 | 100 | 44 | 100 | 76 | 100 |
| tone | | | | | | | | |
| Acid | 62 | 100 | 88 | 100 | 83 | 100 | 87 | 100 |
| value | | | | | | | | |

In any case of using soybean oil, rapeseed oil, palm olein, and blended oil of soybean oil and rapeseed oil (1:1) as a base edible oil seed, the color tone and acid value were significantly lower than those of the corresponding Comparative Examples. Thus, it was found that heat resistance was excellent when any of the edible oil seeds was used.

### Test Example 8

Using the oil and fat compositions of Examples 11 to 16, and Comparative Example 1, the simple heat test was performed. Relative values with respect to the results of Comparative Example 1, which were assumed as 100, were calculated. Table 14 shows the results.

TABLE 14

| | Example | Example | Example | Example | Example | Example | Comparative |
|---|---|---|---|---|---|---|---|
| | 11 | 12 | 13 | 14 | 15 | 16 | Example 1 |
| Phosphorus | 0.1 | 0.8 | 2.7 | 5.0 | 7.5 | 10 | 0 |
| component | | | | | | | |
| (ppm) | | | | | | | |
| Color tone | 92 | 50 | 36 | 65 | 72 | 91 | 100 |
| Acid value | 90 | 90 | 62 | 65 | 68 | 78 | 100 |

When 0.1 to 10 ppm of phosphorus component was added, the color tone and acid value were significantly lower than those of Comparative Example 1. Thus, it was found that the addition of 0.1 to 10 ppm of phosphorus component led to excellent heat resistance.

### Test Example 9

Using the oil and fat compositions of Example 1 and Comparative Example 1, croquettes (New Potato Croquette, produced by Ajinomoto Frozen Food, Inc.) and chicken for frying (broiler chicken for frying, produced by Ajinomoto Frozen Food Inc.) were cooked. It was confirmed that even after frying for 60 hours, the foods cooked with the oil and fat composition of Example 1 showed less deterioration in flavor and could be eaten without any problem, compared to the foods cooked with the oil and fat composition of Comparative Example 1.

1. An oil and fat composition for deep frying, comprising 0.1 ppm or more and 10 ppm or less of a phosphorus component, and ascorbic acid and/or an ascorbic acid derivative in an ascorbic acid equivalent of 2 ppm or more and 130 ppm or less.

2. The oil and fat composition for deep frying according to claim 1, wherein the ascorbic acid derivative is an ascorbic acid ester.

3. The oil and fat composition for deep frying according to claim 2, wherein the ascorbic acid equivalent is 10 ppm or more and 130 ppm or less.

4. The oil and fat composition for deep frying according to claim 1, wherein the phosphorus component is derived from at least one member selected from crude oil and intermediate oil products.

5. A food deep-fried in the oil and fat composition for deep frying according to claim 1.

6. A method for preventing increase in the acid value of an oil and fat composition for deep frying, the method comprising incorporating 0.1 ppm or more and 10 ppm or less of a phosphorus component, and ascorbic acid and/or an ascorbic acid derivative in an ascorbic acid equivalent of 2 ppm or more and 130 ppm or less into an edible oil and fat.

7. A method for preventing coloring of an oil and fat composition for deep frying caused by heating, the method comprising incorporating 0.1 ppm or more and 10 ppm or less of a phosphorus component, and ascorbic acid and/or an ascorbic acid derivative in an ascorbic acid equivalent of 2 ppm or more and 130 ppm or less into an edible oil and fat.

8. A method for producing an oil and fat composition for deep frying, the method comprising incorporating 0.1 ppm or more and 10 ppm or less of a phosphorus component, and ascorbic acid and/or an ascorbic acid derivative in an ascorbic acid equivalent of 2 ppm or more and 130 ppm or less into an edible oil and fat.

9. The method for producing an oil and fat composition for deep frying according to claim 8, wherein a 0.2 to 1% aqueous solution of the ascorbic acid is added to the edible oil and fat, the mixture is dehydrated while stirring at a temperature of 50 to 100° C. at a reduced pressure of 1 to 50 Torr, and after filtration, a phosphorus-derived component is added.

10. The method for producing an oil and fat composition for deep frying according to claim 8, wherein an ascorbic acid ester is added to the edible oil and fat and heated to 50 to 130° C., and then a phosphorus-derived component is added.
